(19) United States
(12) Patent Application Publication
(10) Pub. No.: US 2026/0187110 A1
(43) Pub. Date: Jul. 2, 2026

(54) HIERARCHICAL LANGUAGE MODEL-BASED TASK ORIENTED DIALOGUE SYSTEM

(71) Applicant: Palo Alto Networks, Inc., Santa Clara, CA (US)

(72) Inventors: Bin Wang, Sunnyvale, CA (US); Sam Saeed Hashemi, San Jose, CA (US); Nilesh Kumar Maheshwari, San Jose, CA (US)

(21) Appl. No.: 19/004,997

(22) Filed: Dec. 30, 2024

(51) Int. Cl. G06F 16/3329; G06F 16/3332; G06F 40/35

(52) U.S. Cl. CPC G06F 16/33295; G06F 16/3332; G06F 40/35

(57) ABSTRACT

A system comprising a hierarchy of language model-based subsystems has been created to deliver responses to end-users that are within the scope of their queries. A first subsystem, or “conversation tracker,” receives user queries and tracks conversations with users. The conversation tracker keeps track of the conversation state, which comprises the historical context of a conversation a user has with the system. The conversation tracker additionally rephrases user queries to include the relevant historical context identified from the conversation. The conversation tracker also analyzes each rephrased user query and determines a domain (e.g., knowledge or task domain) to which the rephrased query corresponds applies. The conversation tracker forwards the rephrased queries to one of a plurality of additional subsystems, or “task resolvers,” for generation of responses that are ultimately relayed to the user.

### BACKGROUND

The disclosure generally relates to computing arrangements based on computational models (e.g., CPC G06N) and electrical digital data processing related to handling natural language data (e.g., CPC G06F 40/00).

Dialogue systems are sometimes referred to as chatbots, conversation agents, or digital assistants. While the different terms may correspond to different types of dialogues systems, the commonality is that they provide a conversational user interface. Some functionality of dialogue systems includes intent classification and entity extraction. Task-Oriented Dialogue (TOD) systems are dialogue systems that assist users in completing certain tasks through a conversation dialogue. Through the use of language models, dialogue systems can fine-tune responses to queries by using training data which can vary in scope of specialization.

Rapid developments in artificial intelligence (AI) technologies have spawned numerous terms with fluid meanings. Recently, AI technologies are frequently referred to with the terms large language model (LLM), generative AI, and foundation model. Many of these technologies are based on or relate to the “Transformer” architecture. A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a “foundational model.” The Center for Research on Foundation Models at the Stanford Institute for Human-Centered Artificial Intelligence used this term in an article “On the Opportunities and Risks of Foundation Models” to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data. Some LLMs are based on the Transformer architecture. An LLM is “large” because the training parameters are typically in the billions and have been approaching a trillion parameters. AI technologies are not limited to LLMs and research and utilization of “lightweight” language models (i.e., fewer parameters than large) has grown. Language models can be pre-trained to perform general-purpose tasks or tailored to perform specific tasks.

### BRIEF DESCRIPTION OF THE DRAWINGS

Embodiments of the disclosure may be better understood by referencing the accompanying drawings.

FIG. 1 is a diagram of a conversation tracking system generating a response to a user query by rephrasing the query using conversation context and prompting a task resolver based on the rephrased query.

FIG. 2 is a diagram of an example flow for a conversation tracking system responding to an initial query and a follow up query obtained from a user as part of an ongoing conversation between a user and the conversation tracking system.

FIG. 3 is a flowchart of example operations for answering a query based on a conversation state and determination of a task domain.

FIG. 4 is a flowchart of example operations for evaluating the performance of conversation state updating and query rephrasing.

FIG. 5 is a flowchart of example operations for evaluating performance of the conversation tracking system for query rephrasing and domain determination.

FIG. 6 depicts an example computer system with a conversation tracking system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Task oriented dialogue systems which use a single LLM for customer queries face a myriad of issues as a result of relying on a single LLM to translate customer queries into a set of tasks. Issues can arise such as the task domain of a single LLM growing to a size where accurately mapping tasks to the correct domain can result in inaccurate LLM responses. A system comprising a hierarchy of language model-based (e.g., LLM-based) subsystems has been created to address these issues attributable to a conventional TOD system. The ensemble of language models work conjunctively to deliver responses to end-users that are within the scope of their prompts, maintaining a focus on accuracy and relevance. To accomplish this, the system leverages language models for different tasks performed by hierarchically arranged subsystems as part of responding to customer queries. A first subsystem, or a “conversation tracker” is responsible for receiving user queries, as well as tracking conversations with users. The conversation tracker keeps track of the conversation state, which comprises the historical context of a conversation a user has with the disclosed system. The conversation tracker additionally rephrases user queries to include the relevant historical context identified from the conversation state since user queries may refer to or rely on information previously requested and/or retrieved that is not explicitly included in the queries themselves. The conversation tracker also analyzes a query and determines a knowledge domain (or task domain) to which the intention of the query applies. A collection of additional subsystems, or “task resolvers,” generate the responses to user queries rephrased by the conversation tracker. The conversation tracker passes each user query (or rephrased version thereof) to a respective one of the task resolvers corresponding to the knowledge domain to which the user query has been determined to correspond. Having various task resolvers allows for specialization in specific knowledge domains that is aided by the additional context provided by the conversation tracker, and by keeping a knowledge domain compartmentalized, a task resolver can provide higher quality responses to the end users.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Example Illustrations

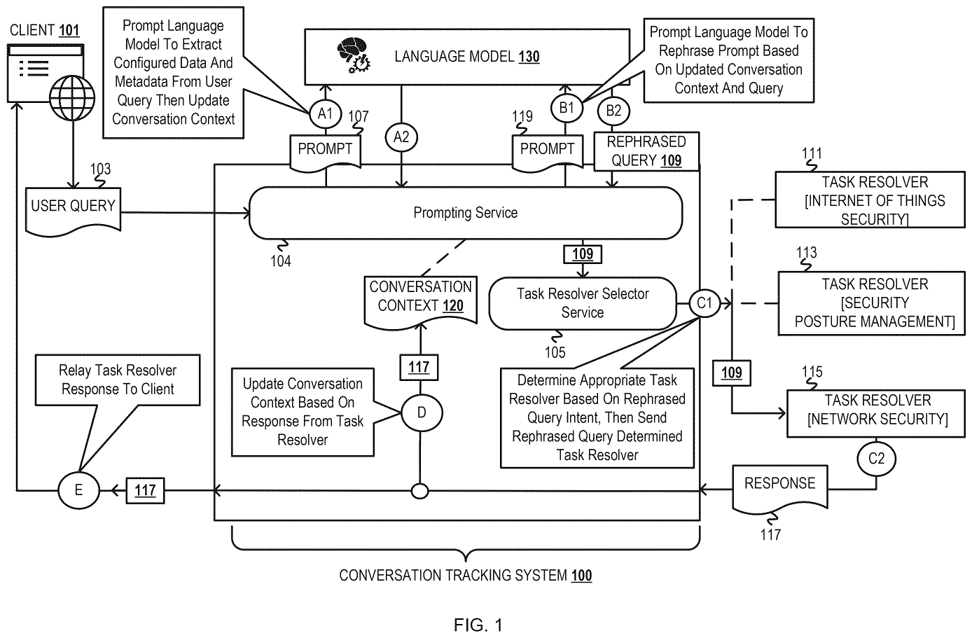

FIG. 1 is a diagram of a conversation tracking system generating a response to a user query by rephrasing the query using conversation context and prompting a task resolver based on the rephrased query. A task resolver is a system or subsystem which resolves tasks utilizing a language model. A task resolver can have an internal language model or a utilize an external language model to resolve tasks provided to it. Task resolver domain language models are generally trained on datasets that are engineered to influence the responses of the language models to be more accurate within a certain knowledge domain, but in some cases may be trained in to give more broad responses.

A conversation tracking system 100 responds to user queries of a client 101 sent as part of a conversation session. A query 103 originating from a user (“user query 103”) is depicted being sent from the client 101 to the conversation tracking system 100. A conversation context 120 is depicted, which stores contextual information of the conversation session between the client 101 and the conversation tracking system 100. FIG. 1 additionally depicts the conversation tracking system 100 as comprising a prompting service 104 and a task resolver selector service 105. The prompting service 104 of the conversation tracking system 100 prompts a language model 130 to determine information in the user query 103 used to update the conversation context 120. The prompting service 104 also prompts the language model 130 to rephrase the user query 103 based on the conversation context 120. The task resolver selector service 105 of the conversation tracking system 100 determines the appropriate task resolver to which to send the rephrased query. The task resolver selector service 105 determines the domain to which the intent of the rephrased query most closely corresponds and selects the task resolver that corresponds to the domain.

FIG. 1 additionally depicts three example task resolvers that assist the conversation tracking system with answering user queries and are labeled based on their domain. A task resolver 111 is depicted as being specialized in the “Internet of Things (IOT) security” domain. A task resolver 113 is specialized in the “security management posture” domain. A task resolver 115 is specialized in the “network security” domain. Each task resolver domain can represent a separate service or subsystem which is specialized in a certain domain (e.g., leverages a certain knowledge base). For instance, as is the case in FIG. 1, each of the task resolvers can correspond to different services of a cybersecurity provider or other vendor.

FIG. 1 is annotated with a series of letters and numbers A1-A2, B1-B2, C1-C2, D and E representing stages of operations, each stage corresponding to one or more operations. Stages A, B and C are separated into substages to illustrate the stages of prompting/requesting and receiving responses from either a language model or service (i.e., a task resolver in this example). Stages A1, B1, and C1 are stages where the conversation tracking system 100 sends a prompt or request to an entity outside the conversation tracking system. Stages A2, B2, and C2 subsequently are stages in which responses are returned for each corresponding prompt/request. Although these stages are ordered for this example, the stages illustrate one example to aid in understanding this disclosure and should not be used to limit the claims. Subject matter falling within the scope of the claims can vary from what is illustrated.

At stage A1, the prompting service 104, upon receiving the user query 103 from the client 101, prompts the language model 130 to determine information from the user query 103 and update the conversation context 120 with the determined information. The user query 103 is sent as part of a first conversation session managed by the conversation tracking system 100. The prompting service 104 determines the conversation session to which the user query 103 corresponds based on a session identifier or other metadata of the user query 103 and identifies the conversation context corresponding to the determined conversation session, or the conversation context 120 in this example. The prompting service 104 generates a prompt 107 and submits the prompt 107 to the language model 130. The prompt 107 to the language model 130 can include one or more example query-conversation context pairs that guide the language model in determining the information to extract and/or infer from the user query 103 for updating the conversation context 120. The prompt 107 also comprises a task instruction to extract and/or infer a plurality of items of information from the user query 103 based on the provided examples. Extracting refers to copying information directly reflected in a user query, while inferring refers to determining data/metadata from the user query that is not explicitly included in the query text. For instance, the prompting service 104 can be configured with a prompt template comprising example user queries and conversation contexts that the prompting service 104 populates with the user query 103 to generate the prompt 107. Some information in the user query such as the natural language query string can be directly extracted from the user query. Other information (e.g., audience or intent) can be inferred based on one or more pieces of data in (e.g., substrings of) the user query 103. For example, using the query string corresponding to a user query that comprises natural language, the intent of the query can be inferred. In some cases, a set of rules may be configured by the conversation tracking system 100 which defines certain data fields that correspond to information which will be extracted from the user query to update the conversation context. At stage A2, the prompting service 104 receives a response from the language model 130 that comprises information corresponding to a conversation context, such as at least a subset of the conversation context with data fields populated based on the information that was extracted/inferred from the user query.

At stage B1, the prompting service 104 prompts the language model 130 to rephrase the user query 103 based on the conversation context 120, which has been updated. The prompting service 104 builds a prompt 119 which includes the user query 103, at least a subset of the updated conversation context 120, and instructions to the language model 130 to rephrase the user query 103 based on the conversation context 120. The prompt 119 also can include a plurality of examples of user queries, conversation contexts corresponding thereto, and the resulting rephrased queries to guide the language model 130 in rephrasing the user query 103 based on the conversation context 120. For instance, the prompting service 104 can be configured with a prompt template that populates with the user query 103 and the conversation context 120 to construct the prompt 119. Rephrasing the user query 103 comprises two main objectives: firstly, to build/engineer a query which includes conversation context while maintaining its original intent, and secondly to rephrase the query such that a downstream task resolver can properly interpret the rephrased query and provide an accurate response. As an illustrative example, in a conversation where a user had previously asked for a listing of alerts for their IoT devices, a subsequent query of “Which ones are the most critical?” may be rephrased as “Which of my IoT device alerts are most critical?” based on the conversation context 120 indicating that the prior query and response pertained to IoT device alerts. While the prompts for extracting/inferring information from the user query 103 to update the conversation context 120 and for rephrasing the user query 103 based on the updated conversation context 120 (i.e., the prompts 107, 119) are depicted as separate in FIG. 1 (e.g., as separate prompts chained via prompt chaining), implementations can prompt the language model 130 to perform each of these tasks in a single prompt. At stage B2, the task resolver selector service 105 receives a response from the language model 130 which includes a rephrased query 109.

At stage C1, the task resolver selector service 105 determines the task resolver to which to send the rephrased query 109. The determination is at least partially based on the task resolver selector service 105 analyzing the rephrased query 109 and determining the intent of the rephrased query 109. The intent of the query can be derived using natural language processing, which parses the rephrased query 109 to infer meaningful components of the rephrased query 109, based on prompting an intent classifier (not depicted in FIG. 1) with the rephrased query 109, etc. Meaningful components specify information about the query such as actions indicated by the query (i.e., create, filter, show, retrieve) and the subject of these actions. From these meaningful components, the intent can be derived. In some cases, techniques such as keyword matching can additionally be used to determine the intent. This example assumes that the task resolver selector service 105 determines that the rephrased query 109 corresponds to the domain of the task resolver 115, or the “Network Security” domain. The task resolver selector service 105 forwards the rephrased query 109 to the task resolver 115. While not depicted in FIG. 1, the task resolver 115 can prompt another language model with a prompt comprising the rephrased query 109, such as based on populating a locally maintained prompt template with the rephrased query 109. At stage C2, the conversation tracking system 100 receives a response 117 from the task resolver 115. The response 117 comprises data and/or metadata that fulfill the rephrased query 109 and thus fulfill the user query 103 initially received.

This example presumes that the conversation tracking system 100 is able to successfully determine a domain to which the rephrased query 109 corresponds. As is further described below, in cases where the conversation tracking system 100 is unable to determine a domain corresponding to the rephrased query 109, the conversation tracking system 100 can request additional information from the user (not depicted in FIG. 1) to assist in domain determination. The information with which the user responds is then used to assist the domain determination.

The three lines connecting the conversation tracking system 100 to each task resolver represent a potential selection the conversation tracking system 100 can make when determining which task resolver to use when responding to user queries from the client 101. The lines pointing to the task resolvers 111 and 113 are dashed to illustrate in this example they were not selected. The solid line between the conversation tracking system 100 and the task resolver 115 illustrates the conversation tracking system 100 selected that task resolver 115 to answer the user query 103 based on determining that the intent of the rephrased query 109 fell under the “Network Security” domain corresponding to the task resolver 115. However, subsequent queries received from the client 101 can correspond to the task resolver 111 and/or the task resolver 113.

At stage D, upon receiving the response 117 from task resolver 115, the conversation tracking system 100 updates the conversation context 120 based on the response 117. Similarly to the operations taken to update the conversation context 120 in stage A1, the conversation tracking system 100 can extract/infer information from the response 117 with which to populate one or more fields of the conversation context 120. Also, similarly to the operations of stage A1, the conversation tracking system 100 may prompt a language model (e.g., the language model 130) to extract and/or infer information from the response 117 with which to update the conversation context 120. Generally, the conversation tracking system 100 will update the conversation context 120 with the response and an indication of the domain to which the response corresponds (i.e., the response 117 and “Network Security” in this example).

At stage E, the conversation tracking system 100 relays the response 117 to the client 101. In some cases, the conversation tracking system 100 can additionally save the responses to an internal or external dataset for use in task resolver or conversation tracking system 100 training, or for analysis of task resolver response quality. Although stages D and E may indicate sequential execution of each stage, in some cases stages D and E can be performed asynchronously.

FIG. 1 depicts the prompting service 104 as submitting a prompt to the language model 130 for each of the tasks of determining information with which to update the conversation context and rephrasing the user query. While this can be achieved through a sequence of prompts, such as with prompt chaining, implementations can combine these tasks into a single prompt to the language model 130. For instance, the prompting service 104 can prompt the language model 130 to extract/infer one or more items of information from a user query and rephrase the user query based on the extracted/inferred information as well as the information already included in the conversation context maintained for the conversation.

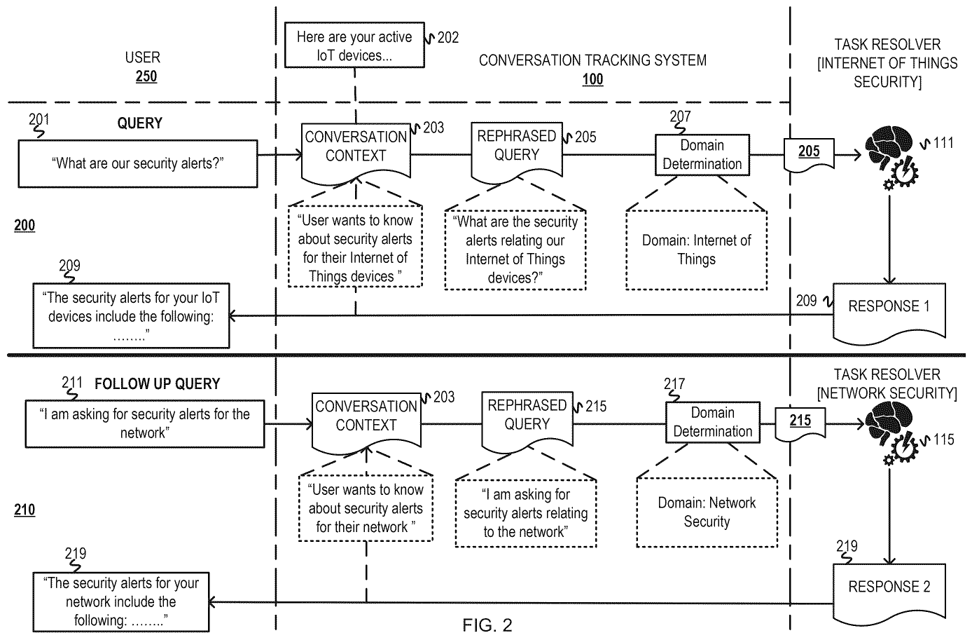

FIG. 2 is a diagram of an example flow for a conversation tracking system responding to an initial query and a follow up query obtained from a user as part of an ongoing conversation between a user and the conversation tracking system. The diagram is depicted with a top flow 200 representing the operations in response to a query 201 and a flow 210 representing the operations in response to a follow-up query 211. The query 201 comprises the example natural language: “What are our security alerts?” The flow 210 depicts the query 201 being sent from a user 250 to the conversation tracking system 100. A conversation context 203 is depicted with data and/or metadata determined based on queries submitted by the user 250 during the current conversation. The conversation context 203 in this example comprises the text, “Here are your active IoT devices,” which may be a summary of a response to a query previously submitted by the user 250. For instance, the user 250 may have previously submitted a query for a listing of their active Internet of Things (IoT) devices. The conversation tracking system 100 thus generates the rephrased query 205 based on the conversation context 203, which provides the context that the user 250 previously submitted a query pertaining to IoT devices. The conversation tracking system 100 generates the rephrased query 205 based on the query 201 and the conversation context 203 based on prompting a language model (e.g., an LLM) as described in reference to FIG. 1.

The conversation tracking system 100 determines a domain 207 to which the rephrased query 205 corresponds as similarly described in reference to FIG. 1. This example gives the domain 207 as being “Internet of Things.” The conversation tracking system 100 forwards the rephrased query 205 being sent to the task resolver 111 that corresponds to the domain of IoT security. The task resolver 111 generates a response 209 to the rephrased query 205 and communicates the response 209 to the conversation tracking system 100. The conversation tracking system 100 also updates the conversation context 203 based on the response 209 obtained from the task resolver 111 as depicted with the dashed line from the response 209 and the conversation context 203 and relays the response 209 back to the user 250.

FIG. 2 further depicts a follow-up query 211 sent by the user 250 to the conversation tracking system 100 with the text: “I am asking for security alerts for the network.” The follow-up query 211 specifies that the security alert information being requested relates to the user's network. The conversation tracking system 100 generates a rephrased query 215 based on the follow-up query 211 and the conversation context 203 by which network security alerts can be retrieved in response to the follow-up query 211. The rephrased query 215 comprises the text: “I am asking for security alerts relating to the network”. The conversation tracking system 101 determines that the rephrased query 215 corresponds to a domain 217, or the domain of network security, which corresponds to the task resolver 115. The conversation tracking system 100 forwards the rephrased query 215 to the task resolver 115. The task resolver 115 generates a response 219 to the rephrased query 215 with the requested data and relays the response 219 to the conversation tracking system 100 for responding to the follow-up query 211. The conversation tracking system 100 also updates the conversation context 203 based on the response 219 as reflected by the dashed line therebetween to aid in rephrasing and responding to subsequent queries submitted by the user 250.

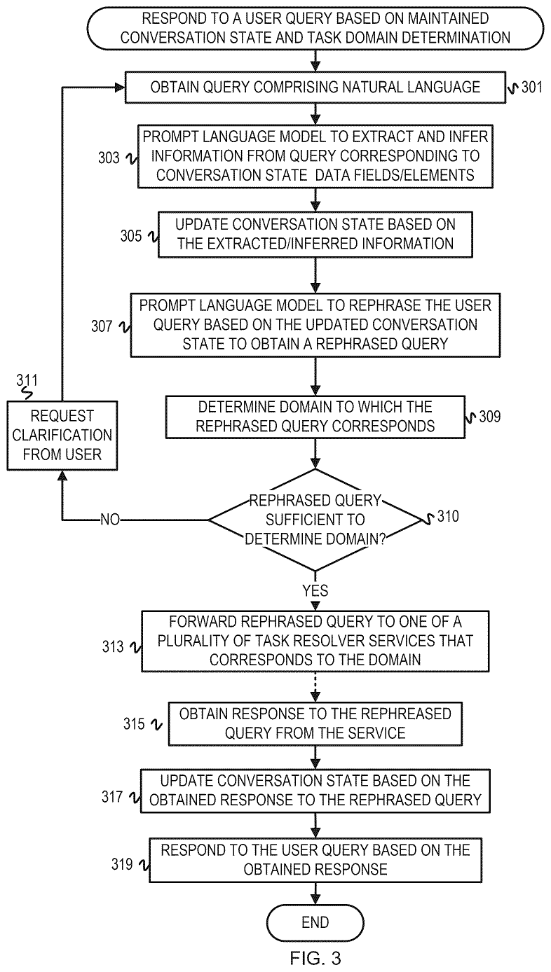

FIGS. 3-5 are flowcharts of example operations. The example operations are described with reference to a conversation tracking system for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. The description's use of the term “conversation state” refers to the information relating to the conversation between a system and an end user similar to the conversation context described above or a belief state in TOD systems.

FIG. 3 is a flowchart of example operations for responding to a user query based on a conversation state and determination of a task domain. At block 301, a conversation tracking system obtains a query comprising natural language. The conversation state tracking system can obtain the query through a dialogue between the conversation state tracking system and a client. Subsequent operations refer to the query as the “original query.”

At block 303, the conversation tracking system prompts a language model to extract and infer information from the query corresponding to a conversation state's data fields or elements. The language model can be an LLM. The conversation state can be implemented with a data structure that stores extracted/inferred information in a plurality of elements, with structured data comprising a plurality of data fields in which extracted/inferred information are stored, etc. An example conversation state structure depicted as being populated with empty values is depicted as follows:

```
{
  ′action′: ‘’,
  ‘target_property’: ‘’,
  ‘entity_with_restrictions': {
    ′original_task′: {
      ′action′ : ‘’,
      ′entity′: ‘’,
    }
  },
  ‘consensus': ‘’,
  ′action_restrictions′: { },
  ′audience′: ‘’,
  ′current_query′: ‘’,
  ′rephrased_query′: ‘’,
  ‘response: ‘’,
  ′response_data′: ‘’,
  ′field_list′: ‘’
}
```

The above example comprises multiple data fields in which information relevant to the current conversation state is stored. The data fields comprise the example fields “action”, “target_property”, “entity_with_restrictions”, “original_task”, “consensus”, “action_restrictions”, “audience”, “current_query”, “rephrased_query”, “answer”, “response_data”, and “field_list”. The “action” field may store an indication of the action associated with a rephrased query. The “target_property” field along with the “entity_with_restrictions” and “action_restrictions” fields may be used to construct the immediate task corresponding to a query. The “target_property” field can store information extracted from a user query corresponding to the requested data. For example, if a user query was: “Tell me applications accessed by the user with the username ‘Mark1313’”, then the “target_property” field could store the value “accessed applications”. The “original_task” field within the “entity_with_restrictions” field is comprised of two sub-fields: “action” and “entity”, which may correspond to the action associated with the original task and the entity associated with the original task, respectively. The values of both the “action” and “entity” fields can be extracted from the user query. The “consensus” field stores information that may be useful across different topics (e.g., multiple tasks) throughout the conversation. (e.g., “The user is asking about data from the past week”). The “action_restrictions” field may store any restrictions extracted or inferred from an original user query. The “audience” field stores information inferred from the original or rephrased query about a target of the query (e.g., one or more task resolvers or the user for more clarifying information). The “current_query” field may store the natural language of an original user query. The “rephrased_query” field may store the natural language of a rephrased query. The “response” field may store the unstructured part of the response obtained from a task resolver (e.g., a summary generated by the task resolver). The “response_data” field stores the structured part of the response, which is generally the data returned from the task resolver in response to the rephrased query. The “field_list” field stores the schema of the response data in the “response_data” field. This is an example conversation state for the purposes of understanding. In implementations, a conversation state can have additional or fewer fields and/or may have different fields. Additionally, some sub-fields may be added to conversation states based on the entities and/or actions that the language model identifies in the query (e.g., entity types, entity identifiers, etc.).

The prompt constructed by the conversation tracking system comprises the conversation state structure, as well as example query and conversation state pairs, where each example comprises an example of a user query and a corresponding conversation state comprising the corresponding information extracted/inferred therefrom, and a task instruction to extract/infer at least a subset of the fields of the conversation state from the provided query (i.e., the original query) based on the examples. For instance, the conversation state tracking system may be configured with a prompt template comprising the conversation state structure, the original query, the example query-conversation state pairs, and this task instruction. The examples guide the language model's determination on which information to extract/infer from the user query. The response from the language model includes the values of the indicated subset of fields of the conversation state structure extracted and/or inferred from the original query. For instance, the response can comprise a conversation state structure with the indicated subset of fields populated based on the user query.

At block 305, the conversation tracking system updates the conversation state based on the extracted/inferred information. Using the information extracted/inferred from the original query indicated in the response from the language model, the conversation state tracker system updates the conversation state maintained for the conversation session to which the user query corresponds. An example of information that can be extracted from the original query can be information such as the original queries' action (e.g., “show”, “retrieve”, etc.) or original task. An example of information that can be inferred from the original query can be information such as audience.

At block 307, the conversation tracking system prompts the language model to rephrase the original query based on the updated conversation state to obtain a rephrased query. The conversation tracking system can use a prompt template that it populates with the user query and the updated conversation state. The prompt template can also include a task instruction to rephrase the user query based on the updated conversation state. The prompt template can be structured in a manner which increases the response quality from the language model based on historical data stored by the conversation state tracker system (e.g., based on prompt engineering based on the historical data).

At block 309, the conversation tracking system determines the domain to which the rephrased query corresponds. The determination of which domain the rephrased query corresponds to can be based at least partly on the intent of the rephrased query. For instance, the conversation state tracking system can determine the intent of the rephrased query by prompting an intent classifier with the rephrased query, where the domain corresponds to the intent. For example, if a rephrased query is determined to comprise a request to retrieve network alerts, then the conversation tracking system could determine that the rephrased query falls into a “Network Security” domain. In other examples, the conversation tracking system can prompt a language model with the rephrased query, a set of supported domains, and examples of queries corresponding to each domain along with a task instruction to determine the domain to which the rephrased query most closely corresponds.

At block 310, the conversation tracking system determines if the rephased query was sufficient to determine the corresponding domain. In some cases, the query even when rephrased does not include enough information sufficient for determining the corresponding domain, such as if the conversation tracking system was unable to determine the intent for the query. This can occur, for instance, when no action is associated with the entity of a rephrased prompt. If the conversation tracking system successfully determines the corresponding domain, operations continue at block 313. Otherwise, operations continue at block 311.

At block 311, the conversation tracking system requests clarification from the user. To provide an illustrative example, if a user prompt is: “Security Alert #1”, then the conversation tracking system's request to the user could be: “What do you want to do with Security Alert #1? Do you need an explanation of this security alert?”. As another example, the conversation tracking system will simply say, “I am sorry, I don't understand. Could you please try rephrasing or providing more context or details?” The conversation tracking system can update the conversation state with an indication that the user was requested to provide clarification, such as by setting an “audience” field of the conversation state to “user” and/or updating an “answer” field with the provided request for clarification. Operational flow continues at block 301 where the conversation tracking system obtains the clarifying information from the user and rephrasing and domain determination can be retried.

At block 313, the conversation tracking system forwards the rephrased query to one of a plurality of task resolver services that corresponds to the domain associated with the rephrased query. The conversation tracking system interfaces with a plurality of task resolver services, each of which corresponds to one of the supported domains. The conversation tracking system selects the task resolver service associated with the domain determined for the rephrased query and forwards the rephrased query to the selected task resolver. The task resolver service receives the rephrased query and generates a prompt based on the rephrased query that it submits to a language model (e.g., an LLM), which may be an internal language model or an external language model (e.g., accessed via an API). As an illustrative example, the prompt can comprise a task instruction to generate a database query representative of the rephrased query (e.g., a Structured Query Language (SQL) query) that the task resolver then executes against a corresponding database to obtain data satisfying the rephrased query.

At block 315, the conversation tracking system obtains the response from the task resolver service. The dashed line between blocks 311 and 313 indicates that the conversation tracking system waits for a response from the task resolver before proceeding to the operations of block 315. The response comprises the data that fulfills the rephrased query and therefore the original query. Returning to the preceding example in which the rephased query is determined to correspond to the “Network Security” domain due to comprising a request for network alerts, the response from the task resolver service should comprise data about network alerts.

At block 317, the conversation tracking system updates the conversation state based on the obtained response to the rephrased query. Updating the conversation state based on the obtained response can be performed similarly to the operations of block 305. For instance, the conversation tracking system can update the conversation state with an indication of the data included in the response (e.g., a summary thereof and/or an indication of the task resolver service that retrieved the data). Returning to the above example, the conversation tracking system may update the fields “response”, “response_data”, and “fields_list” based on the response obtained from the task resolver service.

At block 319, the conversation tracking system responds to the original query based on the obtained response. The conversation tracking system can relay the response obtained from the task resolver service comprising the data fulfilling the original query.

FIG. 3 describes rephrasing a user query based on the conversation state that is maintained. In implementations, the conversation tracking system may not rephrase each query if a received query is sufficient for domain determination and generation of a response as written. In some cases, the rephrased query may be substantially identical to the original query as written, and no rephrasing effectively occurred.

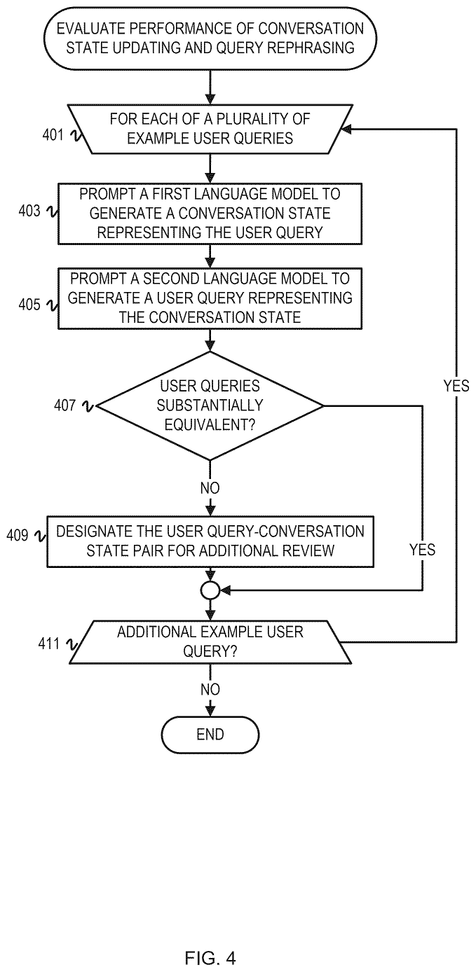

FIG. 4 is a flowchart of example operations for evaluating the performance of conversation state updating and query rephrasing. The example operations presume that a plurality of example user queries has been generated or obtained. As similarly described above, a conversation state structure refers to a structure comprising a plurality of fields of a conversation state used in the rephrasing of user queries.

At block 401, the conversation tracking system begins iterating over a plurality of example user queries. Each of the example user queries comprises natural language. The example user queries may have been obtained from users via submission to the conversation tracking system and/or created based on expert/domain knowledge.

At block 403, the conversation tracking system prompts a first language model to generate or update a conversation state representing the user query. Generating the conversation state representing the user query can be performed as similarly described by the operations described in block 303 of FIG. 3 (e.g., based on use of a prompt template). An example prompt for generating a conversation state from a user query is as follows:

Given a query, rephrase the query so that the action, entity and restriction on entities are listed separately.
The data schemas are described in JSON schema format.
As an example, for the schema {“properties”: {“foo”: {“title”: “Foo”, “description”: “a list of strings”, “type”: “array”, “items”: {“type”: “string” }}}, “required”: [“foo” ]}
the object {“foo”: [“bar”, “baz” ]} is a well-formatted instance of the schema.
   The object {“properties”: {“foo”: [“bar”, “baz” ]}} is not well-formatted.
   The rephrased query needs to be a valid JSON format in the schema of {{{format_schema}}}
   The Boolean values needs to be “True” and “False” in string format instead of raw true and false.
   If the user only says a single noun term, request additional information from the user to clarify.
   Some examples are:
   The query “What is the status of branch FASH?” will be formatted as:

```
{
  “action”: “show”,
  “target_property”: “status”,
    “entity_with_restrictions”: {
      “branch”: {
        “type”: “FASH”
      }
    }
}
...
```

At block 405, the conversation tracking system prompts a second language model to generate a user query representing the conversation state. Generating the user query representing the conversation state should have the effect of rephrasing the example user query based on the conversation state. Generating the user query can be performed as similarly described above in block 307 of FIG. 3. An example prompt for generating a query representing a conversation state is as follows:

Given a JSON object that represents a query to be finished, output the query in natural language form without any explanation.
The JSON object schema is:
{{{json_schema}}}
   The output needs to be in proper English. For example, it should always be “my site”. Phrases like “site my” are not considered proper.
   Some examples can be:
   For the task object as:

```
{
  “action”: “show”,
  “target_property”: “status”,
  “entity_with_restrictions”: {
  “branch”: {
  “type”: “FASH”
},
```

the query in natural language is:
“Show the status of branch FASH?”
   For the task object as

```
{
  “action”: “show trend”,
  “target_property”: “operational status”,
  “entity_with_restrictions”: {
  “branch sites”: {
  “owner”: “current user”,
  “site time”: “last 7 days”
},
```

the query in natural language is:
“Show the operational status trend for the branch sites which are owned by current user over last 7 days.”

At block 407, the conversation tracking system determines if the user query generated in block 405 is substantively equivalent to the selected example query. Substantive equivalence essentially means that both user queries have the same action and entities associated with the queries and that any additional information substantive to the intent of the example user query is also the same (e.g., action restrictions). Information included in the example and generated user queries does not necessarily need to be presented in the same order or phrased in the same way to be considered equivalent. This determination can be performed by the conversation tracking system prompting a language model to evaluate the equivalence of the user queries. An example prompt to evaluate the user queries is as follows:

As a professional auditor of rephrased user queries, your duty is to make sure the rephrased user query is exactly equivalent to the original one.
Your task is divided into three parts:
1. The intention or action of the two provided queries are identical.
2. The entities that is mentioned in the two provided queries are exactly the same.
3. The property or restrictions on each mentioned entity are exactly the same.
   There is some domain knowledge that matters:
It is worth noting that “my” means “current user” in the queries.
“What happened to” an entity is equivalent to asking about the current state of the entity which is the same as showing the entity.
Users that are connecting to a service or application is the same as using the service or application.
“The entity” and “an entity” is the same since the context will make the entity clear.
A service that a user/group of users is “running” is the same as the user/group of users is owning/connecting to.
With a clear time range specification, the tense of the verb in the query does not really matter.
Time range like “over the past x days” and “between past x days” are considered the same. It does not matter whether the query includes now or not.
The result needs to be formatted in a JSON format. Some examples are Example 1:
   Give the original query of “how many datacenters are operationally up?” and rephrased query of “Count datacenters which are in operational status up.”, the audit result is

```
{
  “goal_consistency”: true,
  “goal_consistency_explanation”: “Both of the queries are about getting the
  number of data centers which are up. So their goals are consistent.”,
  “entity_consistency”: true,
  “inconsistent_entities”: { }
}
```

If the user queries are determined to be substantively equivalent, then operational flow continues at block 411, otherwise operational flow continues at block 409.

At block 409, the conversation tracking system designates the user query-conversation state pair for additional review. For instance, the conversation tracking system can add the user query-conversation state pair to a report or notification, store the user query-conversation pair in a database, etc. The review can comprise sending the user query-conversation state pair to a service that performs analysis on the user query and conversation state to determine why the conversation tracking system was not either generate the conversation state, and/or generate the rephrased query successfully. Alternatively, manual analysis of the user query and conversation state can be performed based on expert/domain knowledge (e.g., by a user of the conversation tracking system with expert knowledge of the state updating and query rephrasing processes).

At block 411, the conversation tracking system determines if there is another example user query to utilize for evaluation of the conversation state updating and query rephrasing. If there is another example user query, then operational flow continues at block 401. Otherwise, operational flow concludes.

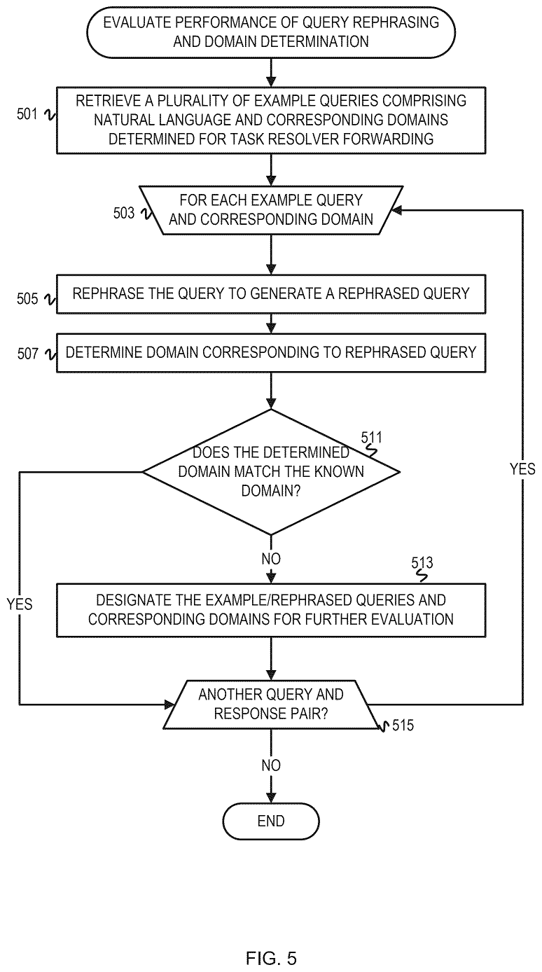

FIG. 5 is a flowchart of example operations for evaluating performance of the conversation tracking system for query rephrasing and domain determination. Evaluating performance for this purpose ensures that rephrased queries are being forwarded to the correct task resolver.

At block 501, the conversation tracking system retrieves a plurality of pairs of example queries comprising natural language and their corresponding domains for forwarding to a task resolver. For example, if a task resolver had the domain “Network Security”, then an example query could correspond to the task “retrieve security alerts for network infrastructure.” These example queries and domains can be retrieved from historical query and domain information that has been stored and/or curated based on expert review. Alternatively, a language model can be prompted to generate example queries based on a plurality of known domains for which task resolvers have been developed.

At block 503, the conversation tracking system begins iterating through each query and corresponding domain. The queries can comprise a curated set of actual queries submitted by users and/or queries generated by experts.

At block 505, the conversation tracking system rephrases the query to generate a rephrased query. Rephrasing the query can be performed as similarly described in block 307 of FIG. 3.

At block 507, the conversation tracking system determines the domain corresponding to the rephrased query. Domain determination can be performed as similarly described in block 309 of FIG. 3.

At block 511, the conversation tracking system checks if the determined domain for the rephrased query matches the known domain of the example query. The known domain that was previously determined for the example query thus serves as a ground truth to inform whether the query rephrasing is maintaining the intent and domain-specific information of the original queries If the domain for the example query and the rephrased query do not match, then operational flow continues at block 513. Otherwise, operational flow continues at block 515.

At block 513, the conversation tracking system designates the example and rephrased queries and the corresponding domains for further evaluation. A domain determination that does not match the expected domain determination (i.e., based on expectation that example query domain determination would be the same as the rephrased query domain determination) is therefore indicative of errors in query rephrasing. The conversation tracking system can add the example/rephrased query and domains to a report, store the example/rephrased query and domains (e.g., in a database or data structure), etc. that is provided or made available for further evaluation and adjustment of query rephrasing. This can include modifying which fields that the conversation tracking system uses from the conversation state to rephrase user queries, revising the prompt template for rephrasing (e.g., by reordering information included in the prompt template), generating additional examples for inclusion in the prompt template, etc. In implementations, in lieu of performing adjustments to the prompt template (i.e., prompt engineering), the language model(s) used for query rephrasing and/or domain determination can be further adapted for either or both tasks through fine-tuning, prompt-tuning, or through other training techniques using additional example queries and their corresponding domains. Evaluation and adjusting for query rephrasing performance improvement can be performed in an ongoing manner, where new example queries and their domains pairs are retrieved to re-evaluate the performance of query rephrasing and domain determination after performing the adjustments.

At block 515, the conversation tracking system determines if another query and response pair is remaining to be processed. If there is another query and response pair, then operations continue at block 503. Otherwise, operations are complete.

### Variations

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 315 and 317 can be performed at least partially in parallel or concurrently. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

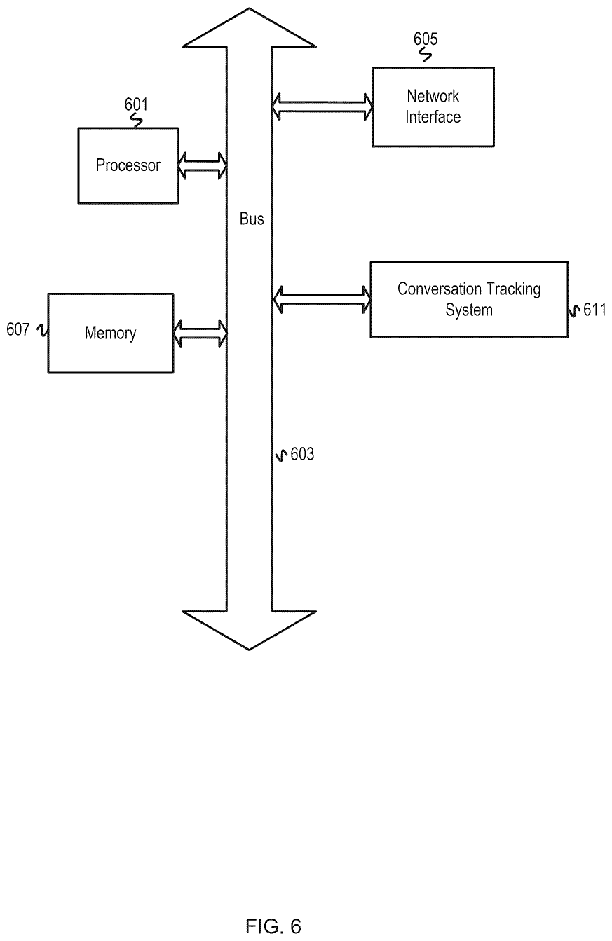

FIG. 6 depicts an example computer system with a conversation tracking system. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a conversation state tracking system 611. The conversation state tracking system 611 obtains a user query submitted by a user as part of a dialogue with the conversation tracking system and prompts a foundation model, such as a language model (e.g., an LLM), to extract or infer information from the user query used to update a conversation state, also referred to herein as its “context.” Then, the conversation tracking system prompts a foundation model (which may be the same foundation model) to rephrase the user query based on the conversation state that was updated. The conversation tracking system determines which of a plurality of domains (e.g., knowledge domains/task domains) the rephrased query corresponds to based at least partly on the rephrased queries' intent and forwards the rephrased query to a task resolver service corresponding to the determined domain. Upon receiving a response from the task resolver service, the conversation tracking system updates its conversation state based on the task resolver service's response then relays the response, which comprises data that fulfills the user query, to the user. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
based on obtaining a user query comprising natural language that corresponds to a first conversation session, updating a context of the first conversation session based on the user query, wherein updating the context of the first conversation session comprises extracting and inferring information from the user query and updating the context with the information;
rephrasing the user query based on the context of the first conversation session to generate a rephrased query, wherein rephrasing the user query comprises prompting a first language model with the user query and the context of the first conversation session;
determining that the rephrased query corresponds to a first domain of a plurality of domains;
forwarding the rephrased query to a first service of a plurality of services that corresponds to the first domain; and
based on obtaining a response to the rephrased query from the first service, updating the context of the first conversation session based on the response to the rephrased query.

2. The method of claim 1, wherein updating the context of the first conversation session comprises prompting a second language model to extract a first subset of the information from the user query and to infer a second subset of the information from the user query.

3. The method of claim 2, wherein prompting the second language model to extract the first subset of information and to infer the second subset of information from the user query comprises submitting a prompt to the second language model comprising the user query, a plurality of examples of user queries and corresponding information extracted from the user queries, and a task instruction to extract the first subset of information and infer the second subset of information from the user query based on the plurality of examples.

4. The method of claim 1, further comprising generating a response to the user query based on the response to the rephrased query and responding to the user query with the generated response.

5. The method of claim 1, wherein prompting the first language model comprises,
generating a prompt comprising the user query, the context of the first conversation session, and a task instruction to rephrase the user query based on the context of the first conversation session; and
submitting the prompt to the first language model, wherein a response to the prompt obtained from the first language model comprises the rephrased query.

6. The method of claim 5, wherein the prompt further comprises a plurality of examples of user queries and rephrased queries based on corresponding contexts of conversation sessions.

7. The method of claim 1, wherein determining that the user query corresponds to the first domain comprises determining intent of the user query and determining that the user query corresponds to the first domain based at least partly on the intent of the user query.

8. The method of claim 1, further comprising updating the context of the first conversation session to indicate the rephrased query.

9. The method of claim 1,
wherein updating the context of the first conversation session based on the user query comprises updating a data structure with the information extracted and inferred from the user query,
wherein updating the context of the first conversation session based on the response to the rephrased query comprises updating the data structure with information that is at least one of extracted and inferred from the response to the rephrased query.

10. The method of claim 1, wherein each of the plurality of services interfaces with a corresponding one of a plurality of language models to generate responses to rephrased queries, wherein the first language model differs from the plurality of language models.

11. One or more non-transitory machine-readable media having program code stored thereon, the program code comprising instructions to:
update a maintained state of a first conversation based on a first query comprising natural language that corresponds to the first conversation, wherein the instructions to update the maintained state of the first conversation comprise instructions to determine information from the first query and update the maintained state with the determined information;
generate a rephrased query based on the first query and the maintained state of the first conversation, wherein the instructions to generate the rephrased query comprise instructions to prompt a first foundation model with the first query and the maintained state of the first conversation, wherein the rephrased query incorporates context of the first conversation identified from the maintained state of the first conversation;
determine a destination of the rephrased query based on intent of the rephrased query, wherein the destination of the rephrased query corresponds to a first task resolver of a plurality of task resolvers that corresponds to a plurality of task domains;
route the rephrased query to the determined destination to obtain a response to the rephrased query from the first task resolver; and
update the maintained state of the first conversation based on the response to the first query.

12. The non-transitory machine-readable media of claim 11,
wherein the instructions to determine the information from the first query further comprise instructions to prompt a second foundation model to determine information from the first query,
wherein the instructions to prompt the second foundation model comprise instructions to submit a prompt to the second foundation model comprising the first query, a plurality of examples of queries comprising natural language and corresponding information determined from the queries, and a task instruction to determine the information from the first query based on the plurality of examples.

13. The non-transitory machine-readable media of claim 11, wherein the instructions to determine the destination of the rephrased query comprise instructions to determine that the rephrased query corresponds to a first task domain of the plurality of task domains based at least partly on the intent of the rephrased query, wherein the first task domain corresponds to the first task resolver.

14. The non-transitory machine-readable media of claim 11, wherein the instructions to prompt the first foundation model comprise instructions to,
generate a prompt comprising the first query, the maintained state of the first conversation, a plurality of examples of queries comprising natural language and rephrased versions of the queries based on corresponding conversation states, and a task instruction to rephrase the first query based on context provided by the maintained state of the first conversation and the plurality of examples; and
submit the prompt to the first foundation model, wherein a response to the prompt obtained from the first foundation model comprises the rephrased query.

15. An apparatus comprising:
a processor; and
a computer-readable medium having instructions stored thereon that are executable by the processor to cause the apparatus to,
during a first conversation that at least includes a plurality of user queries and a plurality of responses from at least one of a plurality of language models, for each user query of the plurality of user queries,
extract first information and infer second information from the user query;
update a context for the first conversation with the first and second information to generate an updated context for the first conversation;
rephrase the user query based on the updated context to generate a rephrased user query;
determine a task domain based on the rephrased user query;
identify a first service of a plurality of services to handle the rephrased user query based on the task domain, wherein each of the plurality of services corresponds to one of the plurality of language models; and
communicate the rephrased user query to the first service to obtain in response a corresponding one of the plurality of responses; and
for each response of the plurality of responses, update the context for the first conversation based on the response.

16. The apparatus of claim 15, wherein the instructions executable by the processor to cause the apparatus to extract the first information and infer the second information from the user query comprise instructions executable by the processor to cause the apparatus to prompt a language model to extract the first information and infer the second information from the user query, wherein the language model differs from the plurality of language models.

17. The apparatus of claim 16, wherein the instructions to prompt the language model comprise instructions to submit a prompt to the language model comprising the user query, a plurality of examples of user queries and corresponding information determined from the user queries, and a task instruction to extract the first information and infer the second information from the user query based on the plurality of examples.

18. The apparatus of claim 15, wherein the instructions executable by the processor to cause the apparatus to determine the task domain based on the rephrased user query comprise instructions to determine the task domain based at least partly on a determined intent of the rephrased user query.

19. The apparatus of claim 15, wherein the instructions executable by the processor to cause the apparatus to rephrase the user query comprise instructions executable by the processor to cause the apparatus to submit a prompt to a language model comprising the user query, the updated context, one or more examples of user queries and rephrased versions of the user queries based on corresponding conversation contexts, and a task instruction to rephrase the user query based on the updated context and the one or more examples.

20. The apparatus of claim 15,
wherein the instructions executable by the processor to cause the apparatus to update the context for the first conversation comprise instructions executable by the processor to cause the apparatus to update a data structure with the first and second information,
wherein the instructions executable by the processor to cause the apparatus to update the context for the first conversation based on the response comprise instructions executable by the processor to cause the apparatus to update the data structure to indicate the response.
